(19) United States
(12) Patent Application Publication
(10) Pub. No.: US 2005/0066704 A1
(43) Pub. Date: Mar. 31, 2005

(54) Method and device for the electrical zero balancing for a micromechanical component

(76) Inventors: Leo Tanten, Reutlingen (DE); Jochen Franz, Reutlingen (DE); Martin Schoefthaler, Reutlingen (DE); Marius Rohr, Reutlingen (DE); Harald Emmerich, Reutlingen (DE); Matthias Maute, Ostfildern (DE); Thomas Walker, Kusterdingen (DE)

Correspondence Address: KENYON & KENYON, ONE BROADWAY, NEW YORK, NY, 10004, US

(21) Appl. No.: 10/381,992

(22) PCT Filed: Jun. 1, 2001
(86) PCT No.: PCT/DE01/02066

(30) Foreign Application Priority Data
Oct. 6, 2000 (DE) 10049462.5

(51) Int. Cl. G01P 21/00

(52) U.S. Cl. 73/1.88; 73/1.38; 324/601

(57) ABSTRACT

A method for the electrical zero balancing of a micro mechanical component including a first capacitor electrode rigidly suspended over a substrate, a second capacitor electrode rigidly suspended over the substrate, and a third capacitor electrode disposed there between, resiliently and deflectably suspended over the substrate, as well as a differential-capacitance detector for measuring a differential capacitance of the capacitances of the variable capacitors configured in this manner. In this context, a first electric potential is applied to the first capacitor electrode; a second electric potential is applied to the second capacitor electrode; a third electric potential is applied to the third capacitor electrode; and a fourth electric potential is applied to the substrate. The fourth electrical potential applied to the substrate for the electrical zero-point balancing is changed for the operation of the differential-capacitance detector.

### FIELD OF THE INVENTION

The present invention relates to a method and a device for the electrical zero balancing of a micro mechanical component including a first capacitor electrode rigidly suspended over a substrate, a second capacitor electrode rigidly suspended over the substrate, and a third capacitor electrode disposed there between, resiliently and deflectably suspended over the substrate, as well as a differential-capacitance detector for measuring the differential capacitance of the capacitances of the variable capacitors configured in this manner.

Although applicable to any number of micro mechanical components and structures, particularly sensors and actuators, the present invention, as well as its basic underlying problem definition are explained with reference to a micro mechanical Coriolis acceleration sensor of a rotation-rate sensor that is manufacturable using the technology of silicon surface micromechanics.

### BACKGROUND INFORMATION

Acceleration sensors in general and micro mechanical acceleration sensors in particular, based on the technology of surface or volume micromechanics, are gaining ever greater market shares in the automotive equipment sector and are increasingly replacing the piezoelectric acceleration sensors that have been standard till now.

Micro mechanical acceleration sensors of other systems may function in such a manner that the resiliently supported seismic mass device, which is deflectable in response to an external acceleration in at least one direction, when deflected, effects a change in capacitance at a differential-capacitor device connected thereto, this change is a measure of the acceleration. It is customary for these elements to be structurally formed in polysilicon, e.g., epitaxial polysilicon, over a sacrificial layer of oxide.

However, micro mechanical sensor elements are not only generally used to detect linear and rotative accelerations, but also to detect gradients and rotational speeds. In this context, the differential-capacitive measuring principle may apply, according to which the measured quantity, for example the acceleration, causes a positional change in a movable capacitor electrode of a micro mechanical sensor structure, which induces two corresponding fixed capacitor electrodes, positioned on both sides of the movable capacitor electrode, to change their electrical measurement capacitance values in the opposite sense. In other words, the capacitance of the one capacitor increases by a specific amount, and the capacitance of the other capacitor formed in such a manner, decreases by a corresponding value, and, in fact, due to corresponding changes in the capacitor electrode distances.

The smallest asymmetries in the zero position of such measuring structures or in the parasitic capacitance components of the micro mechanical sensor element in question lead, in the process, to an electrical offset or an electrical zero-point displacement at the output of the sensor element. Such an offset may be compensated when balancing an individual sensor by adding an appropriate voltage or an appropriate current in the relevant signal path of the differential-capacitance detector.

By intervening in this manner in the relevant signal path when balancing the sensor offset, it may happen that other functional parameters are negatively influenced, for example, temperature sensitivities may arise in the offset or the signal amplifications and the sensor sensitivity or the like may change simultaneously. This leads then to further compensation and balancing requirements and substantially increases the outlay for sensor balancing.

In addition, the gradation of such an offset balancing is dependent upon the total amplification of the signal path in question, for example upon the nominal sensitivity to be balanced, provided that at least some of the amplification balancing is not performed until after the offset-compensation point.

### SUMMARY OF THE INVENTION

The exemplary method according to the present invention for the electrical zero balancing of a micro mechanical component may provide that the offset balancing or the zero-point balancing of a micromechanical, capacitively evaluated sensor element may be performed outside of the sensitive signal path, i.e., independently of amplification factors, and without introducing parasitic signal distortions, caused, for example, by responses to temperature changes.

The idea underlying the present invention is that the fourth electrical potential applied to the substrate for the electrical zero-point balancing, is changed for the operation of the differential-capacitance detector.

In accordance with an exemplary embodiment, the potentials required for measuring differential capacitance are able to be applied in a clocked cycle.

In accordance with another exemplary embodiment, the micro mechanical component includes an interdigital capacitor device including a multiplicity of movable and fixed capacitor electrodes.

### BRIEF DESCRIPTION OF THE DRAWINGS

FIG. 1 shows a part-sectional view of an acceleration sensor according to an exemplary embodiment of the present invention, in the context of a first substrate potential.

FIG. 2 shows a part-sectional view of the acceleration sensor according to an exemplary embodiment of the present invention, in the context of a second substrate potential.

### DETAILED DESCRIPTION

In the figures, components which are the same or functionally equivalent are denoted by the same reference numerals.

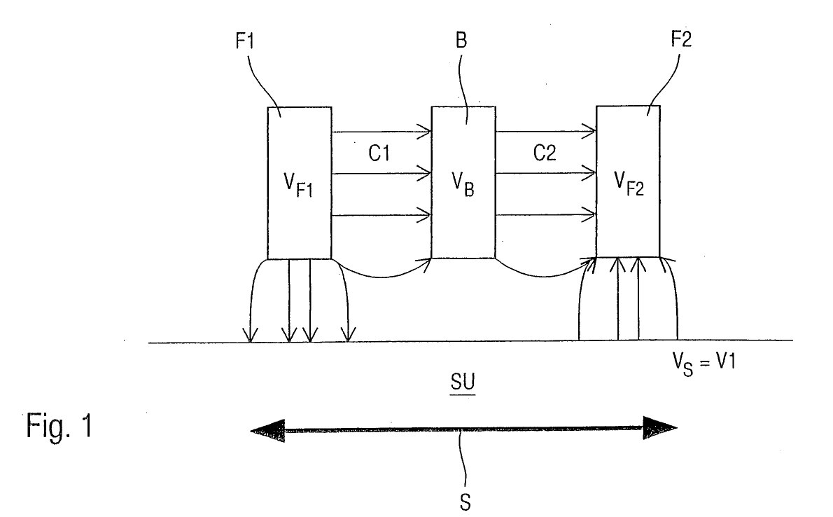

FIG. 1 shows a part-sectional view of an acceleration sensor according to an exemplary embodiment of the present invention, in the context of a first substrate potential. The schematized sectional view shown in FIG. 1 illustrates three capacitor electrodes for a differential-capacitive signal evaluation. In this context, in FIG. 1, F1 denotes a first capacitor electrode rigidly suspended over a substrate SU; F2 a second capacitor electrode rigidly suspended over substrate SU; and B a third capacitor electrode disposed there between, deflectably suspended over substrate SU. Third capacitor electrode B is able to be returned to its neutral position via a spring device.

The three electrodes F1, B, F2 are connected to a differential-capacitance detector (not shown) to measure a differential capacitance of the capacitances C1, C2 of variable capacitors F1, B; B, F2 configured in this manner.

Electric potential V_{F1} is applied to first fixed capacitor electrode F1; electric potential VF₂ is applied to second capacitor electrode F2; and electric potential VB is applied to the third capacitor electrode. For example, V_{F1} is=5 V, V_{F2} =0 V, and VB=2.5 V. In addition, electric potential V_{S}=V1 of, e.g., 2.5 V is applied to substrate SU. Furthermore, the electric field line pattern derived therefrom is schematically indicated in FIG. 1. The double arrow in the figure indicates the detection directions for deflections of movable third capacitor electrode B.

In this context, the potentials required for capacitance measurement, in practice, are not statically applied to the capacitor electrodes, but rather in a clocked cycle.

To facilitate the description, one assumes a full symmetry of the distances of capacitor electrodes F1, F2, B to one another, but an asymmetry for the parasitic capacitances, so that a zero-point balancing is required.

The resulting force acting in detecting direction S on movable third capacitor electrode B is assumed to be zero for electric potentials V₁, V_{B}, V_{F2}, V_{S} applied in accordance with FIG. 1.

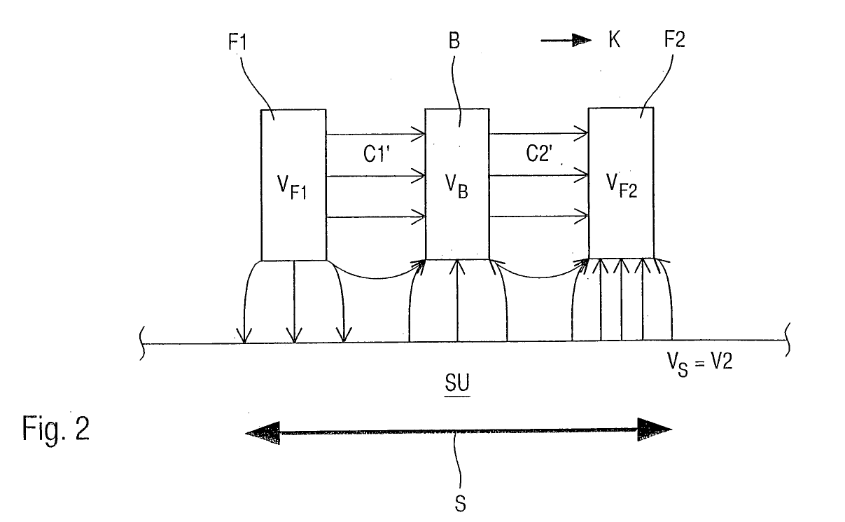

FIG. 2 shows a part-sectional view of an acceleration sensor according to an exemplary embodiment of the present invention, in the context of a first substrate potential.

If electric potential V_{S} of substrate SU is now changed from V1=2.5 V to V2=3 V, then, depending on the direction of change, as the result of a developing asymmetrical lateral field-line distribution, a small electric force K may be exerted in a detecting direction S on movable capacitor electrode B. In other words, due to the change in electric potential V_{S} of substrate SU from V1=2.5 V to V2 =3 V, the electric field lines are distorted, which leads to resulting force K.

This force K leads to a lateral deflection of movable capacitor electrode B and thus to an adjustment of capacitance values C1, C2 to new capacitance values C1′, C2′ from both capacitors F1, B; B, F2 and, thus, to a change in the zero point at the output of the differential-capacitance detector.

For an electric potential V_{S} of substrate SU that would be lower than that of movable capacitor electrode B, a force would result in a direction opposite to that of FIG. 2.

What is important in this context is that electric potential V_{S} of substrate SU be variable, completely independently of the signal-amplification path.

Although the present invention is described above on the basis of an exemplary embodiment, it is not limited thereto, and may be modified in numerous manners.

In the above examples, the acceleration sensor according to the present invention is explained in order to elucidate its basic principles. One may, of course, conceive of combinations of the examples and substantially more complicated refinements, while employing the same elements or method steps.

Any micro mechanical base materials may also be used, and not only the silicon substrate cited here exemplarily.

1-6. Cancelled

7. A method for electrical zero balancing a micro-mechanical component which includes a first capacitor electrode rigidly suspended over a substrate, a second capacitor electrode rigidly suspended over the substrate, a third capacitor electrode arranged between the first capacitor electrode and the second capacitor electrode and resiliently and deflectably suspended over the substrate, and a differential-capacitance detector for measuring a differential capacitance of the capacitances of a plurality of variable capacitors:
applying a first electric potential to the first capacitor electrode;
applying a second electric potential to the second capacitor electrode; and
applying a third electric potential to the third capacitor electrode; and
applying a fourth electric potential to the substrate, wherein the fourth electrical potential applied to the substrate for the electrical zero-point balancing is changed for operation of the differential-capacitance detector.

8. The method of claim 7, wherein the first electric potential, the second electric potential, the third electric potential, and the fourth electric potential required for measuring the differential capacitance are applied in a clocked cycle.

9. The method of claim 7, wherein the micro-mechanical component includes an interdigital capacitor device with movable capacitor electrodes and fixed capacitor electrodes.

10. A device for electrical zero balancing of a micro-mechanical component, which includes a first capacitor electrode rigidly suspended over a substrate, a second capacitor electrode rigidly suspended over the substrate, a third capacitor electrode arranged between the first capacitor electrode and the second capacitor electrode and resiliently and deflectably suspended over the substrate, and a differential-capacitance detector for measuring a differential capacitance of a plurality of capacitances of a plurality of variable capacitors, the device comprising:
a potential-supplying device to apply a first electric potential to the first capacitor electrode, to apply a second electric potential to the second capacitor electrode, to apply a third electric potential to the third capacitor electrode, and to apply a fourth electric potential to the substrate, wherein the potential-supplying device is able to vary the fourth electrical potential applied to the substrate for the electrical zero-point balancing for operation of the differential-capacitance detector.

11. The device of claim 10, wherein the first electric potential, the second electric potential, the third electric potential, and the fourth electric potential required for measuring the differential capacitance are applied in a clocked cycle.

12. The device of claim 10, wherein the micro-mechanical component includes an
